(19) United States
(12) Patent Application Publication
(10) Pub. No.: US 2008/0187760 A1
(43) Pub. Date: Aug. 7, 2008

(54) Gradient Photochromic Articles and Their Method of Making

(76) Inventor: Ronald C. Wiand, Troy, MI (US)

Correspondence Address: RONALD L. HOFER, 122 LINDBERGH LANE, MOORESVILLE, NC, 28117, US

(21) Appl. No.: 11/883,870

(22) PCT Filed: Feb. 7, 2006
(86) PCT No.: PCT/US06/04282

§ 371 Date: Aug. 7, 2007

Related U.S. Application Data
(60) Provisional application No. 60/651,138, filed on Feb. 8, 2005.

(51) Int. Cl. B32B 27/36; C08G 63/60; G02B 1/04; B32B 9/04

(52) U.S. Cl. 428/412; 524/1; 524/599; 428/411.1

(57) ABSTRACT

An article such as an ophthalmic lens has a layer of a cross-linked organic polymeric matrix containing a tinting material in a gradient concentration. The tinting material is a dye, a photochromic moiety or a combination of a dye and a photochromic moiety. Various methods of making the article are disclosed.

### BACKGROUND OF THE INVENTION

The present invention relates to photochromic articles having a gradient tint and to a method of making such gradient photochromic articles. In one preferred embodiment, the present invention relates to ophthalmic or planar lenses having a photochromic layer which contains a photochromic moiety in a concentration which varies from one portion to another portion of the layer.

Photochromic lenses are aesthetically pleasing and functional and have been popular for many years. Photochromic lenses can be transparent during low light conditions but darken to protect the eye when exposed to bright sunlight. It is, of course, the photochromic material in the lens which changes state under the different light conditions to give the lens its photochromic nature.

Although glass lenses with photochromic characteristics are advantageous, photochromic plastic lenses are even more advantageous because they are relatively light in weight and can be thinner and more resistant to shattering. Although plastic lenses are not as hard as glass lenses, they can be coated with a scratch resistant coating to make them scratch resistant. There remains a need, however, for improvements in photochromic plastic lenses. The photochromic molecules used in plastic lenses are relatively large in size and are difficult to incorporate into a polymerized plastic polymeric matrix. Difficulties also arise if the polymeric matrix interferes with the changing of states of the photo chromic molecule. Furthermore, it has been found to be difficult to provide photochromic lenses with a gradient effect.

Several different techniques are known for adding photochromic material to plastic lenses. In the “casting” technique, the photo chromic material is added to a polymerizable optical quality monomer before polymerization and then the mixture is cast in a mold wherein the monomer is polymerized to provide a full body photochromic lens which is a homogeneous mixture of polymer and photo chromic material throughout the lens. However, this technique encounters difficulties with regard to providing a lens having even tint or shading from the center of the lens to its edge. If the lens is an ophthalmic lens having a relatively thin optical center area and a relatively thick edge area, the thin center of the lens will have less photochromic additive and will tend to be lighter than the thicker edge providing an undesirable gradient effect.

One variation of casting technique is taught in U.S. Pat. No. 5,882,556 which issued on Mar. 16, 1999 to Perrott et al. for “Method of Preparing Photochromic Article.” In the Perrott et al. method, a cross-linkable polymeric casting composition is subjected to a partial cure, such that the polymer reaches or exceeds its point of gelation, then the partially cured polymer is contacted with a photo chromic composition, and the gelled polymer is finish cured.

Another known technique for adding photo chromic material to a plastic lens is an “imbibing” technique in which a photochromic material is added to a plastic lens by first polymerizing an optical quality monomer in a mold until polymerization is substantially complete, and then permeating the lens or lens surface with a photo chromic material by imhibition, sublimation or other method. This technique provides a layer of photochromic material of consistent depth and thus avoids the problem associated with a lens having a variation in thickness and has become the most prevalent technique in use today. The imbibing technique is, however, relatively complex and expensive. It also tends to be a slow process which is capital intensive and not suitable to be economically carried out in the optical wholesale laboratories which presently surface and edge lenses for most wearers of ophthalmic glasses. It also fails to provide a desirable gradient effect to the photochromic lens.

Another technique for rendering an eyeglass lens photochromic is a “coating” technique. For example, photochromic molecules are deposited onto a lens from a bipolar mixture of solvent and photochromic molecules to form a coating thereon. Then the lens and coating are heated to the melting point of the coating. After the coating has cooled, another coating of hard material is applied over the coating of photochromic molecules to protect the molecules and provide scratch resistance. This technique, however, has met with only limited success and, of course, does not provide a gradient effect.

Although photochromic lenses having a gradient feature are known, there remains a need for improved methods and lenses. Known techniques which involve differentially inhibiting photochromic molecules to obtain the photochromic effect are difficult and expensive to carry out and have met with limited success. Thus, there remains a need for improved methods for providing a gradient effect in plastic lenses.

Dark or tinted lenses which are not photochromic but which are darker at the top of the lense than at the bottom of the lens are also known. Such lenses have a gradient in that they are darker at the upper part of the lens than at the bottom when viewed in the face direction of the lens. This feature is useful in that during use the need for more filtering is greater at the top portion of the lens than at the bottom portion of the lens a gradient effect are known. However, there remains room for improved methods for providing a gradient in these lenses also.

Accordingly the present invention provides an improved method for imparting photochromic qualities to plastic articles. Furthermore, an improved photochromic plastic article is provided. While the present invention is useful to make all sorts of photochromic articles or products, and such articles and products are within the broad scope of the invention disclosed herein. However, the present invention is particularly well suited for use in making gradient lenses for eyeglasses and is especially well suited for making gradient photochromic lenses for eyeglasses. The methods of this invention can be economically carried out in a small optical laboratory without use of complex or expensive equipment or process steps to provide a gradient dye or photochromic lens. Further understanding of this invention will be had from the following disclosure taken in conjunction with the claims and drawing.

### BRIEF SUMMARY OF THE INVENTION

In accordance with the present invention, an article has a layer comprised of a cross-linked organic polymer matrix with a photochromic or tinted dye therein. The layer contains a photochromic moiety in a concentration which varies in in a gradient manner from one portion of the article to another. In a preferred embodiment, the article is transparent or semitransparent. In another preferred embodiment the article is an optical lens. in accordance with the method of the present invention, an article is made by the steps of:
Curing a cross-linkable prepolymer to at least a gel state to form a substrate of a partially cured polymeric matrix, said substrate having a surface layer with a top portion and a bottom portion;
inhibiting further curing of said prepolymer in said surface layer, thereby providing a substrate with an inhibited surface layer and an uninhibited partially cured remainder; and
Infusing a photochromic moiety into said surface layer, said photochromic moiety being more concentrated in the top portion than in the bottom portion of said surface layer.
   The uninhibited partially cured remainder of the substrate is preferably fully cured before the photochromic moiety is infused into the surface layer. However, the uninhibited partially cured remainder can alternatively be cured after the photochromic moiety is infused into the surface layer. The resulting substrate has a porous, partially cured polymeric surface layer containing a photochromic moiety and has a polymeric remainder which is substantially more cross-linked. The photochromic moiety has been applied in a manner to give the surface layer a gradient effect. In one preferred embodiment of the present invention, the method is used to make a transparent article. In another preferred embodiment of the present invention the method is used to make a lens.

### DETAILED DESCRIPTION OF THE INVENTION

The present invention relates to a substrate comprised of a cross-linked organic polymer. The substrate has a layer which contains a tinting material in a gradient concentration. The tinting material is selected from the group consisting of dyes, photochromic moieties and combinations of dyes and photochromic moieties. The layer is a porous matrix so that the dye or photochromic moiety or combination thereof can be infused therein. The term “gradient concentration” refers to a concentration which is greater at one selected portion of the article than at another selected portion of the article with the concentration changing therebetween in a gradient manner. Where the article is a lens, the concentration changes in a gradient from a lower portion of the lens to a higher portion of the lens as viewed toward the face of the lens.

It will be appreciated by those skilled in the art that the present invention is broadly applicable to make substrates which may be used in conjunction with many different products or articles of manufacture. Examples of products which can comprise or include substrates of this invention include but are not limited to window panes, such as window panes in homes or other energy efficient buildings or solar structures, sun roofs, windshields or lites for automobiles, signs, compact discs, digital audio discs, and plastic optical articles generally. While it is contemplated that most advantage will be taken from use of this invention in transparent or semi-transparent products, this invention can be used to make products that are not transparent, where, for example it may be desired to selectively reduce reflection, or to darken or change the color or appearance of the product. Many different products or articles may be produced with a desirable effect. All of these products are considered to be within the broad scope of the present invention.

A preferred embodiment of this invention is a photochromic plastic optical lens. Another preferred embodiment is a photochromic eyeglass frame. A further preferred embodiment is a photochromic eyeglass frame with photochromic lenses Where the embodiment is a lens, the lens may be an ophthalmic lens or a planar lens. Planar lenses are generally of consistent thickness. Ophthalmic lenses may be spherical or aspheric, monofocal, bifocal, trifocal, multifocal, invisible multifocal or progressive, semi-finished or finished plano blank for sunglasses and do not have a consistent thickness from center to edge. Ophthalmic lenses are relatively difficult to coat or infuse with a photochromic moiety to obtain a consistent photochromic effect. In accordance with the present invention, however, a consistent photochromic layer of consistent thickness can be provided in an ophthalmic lens. Of course, it should be noted that in some cases it may be desirable to have a gradient effect in a lens, i.e., greater darkening in a top of the lens than the bottom of the lens. This effect can also be achieved within the scope of this invention.

The products of the present invention can be made by several different methods. For example, one method of the present invention comprises the steps of:
Curing a crosslink-able prepolymer to at least a gel state to form a substrate of a partially cured polymeric matrix, the substrate having a surface and an associated surface layer;
inhibiting further curing of said prepolymer in the surface layer, thereby providing a substrate with an inhibited surface layer and an uninhibited partially cured remainder; and
Infusing an effective amount of a photochromic moiety into said surface layer, said moiety being infused to a greater concentration in an upper part of said layer than in a lower part of said layer.
   The uninhibited partially cured remainder of the substrate is preferably fully cured before the photochromic moiety is infused into the surface layer. However, the uninhibited partially cured remainder can alternatively be cured after the photochromic moiety is infused into the surface layer. The resulting substrate has a porous, partially cured polymeric surface layer containing a photochromic moiety and has a polymeric remainder which is substantially more cured.

The organic polymeric matrix is made from a polymerizable prepolymer that has been polymerized and cross-linked. As used herein, the term prepolymer includes monomeric moieties as well as oligomers, dimers, etc. The prepolymer is polymerized and cross-linked during curing to form a thermoset plastic material. Suitable prepolymers are well known and may be ultraviolate cross-linkable prepolymers, radiation cross-linkable prepolymers or thermally cross-linkable prepolymers. Initiation of polymerization and/or cross-linking may be by ultraviolet or electron beam radiation or heat or a combination thereof.

For an optical quality lens, suitable prepolymers include optical quality polymerizable prepolymers having an index of refraction between 1.45 and 1.90. Suitable prepolymers for use in making lenses are liquid and must be placed in a desired lens mold before initiation of polymerization. Examples of suitable prepolymers include monomers, homopolymers and copolymers of polyol(allyl carbonate) monomers, homopolymers and copolymers of polyfunctional acrylate monomers, polyacrylates, poly(alkylacrylates) such as poly(methylmethacrylate), cellulose acetate, cellulose triacetate, cellulose acetate propionate, cellulose acetate butyrate, poly(vinyl acetate), poly(vinyl alcohol), poly(vinyl chloride), poly(vinylidene chloride), polyurethanes, polycarbonates, poly(ethylene-terephthalate), polystyrene, copoly(styrene-methylmethacralate), copoly(styrene-acrylonitdrile), poly(vinylbutyral), and homopolymers and copolymers of diallylidene pentaerythritol, such as copolymers with polyol(allyl carbonate) monomers, e.g. diethylene glycol bis(allyl carbonate), and acrylate monomers. Transparent copolymers and blends of the transparent polymers are suitable as matrix materials. Preferred prepolymers are diethlene glycol Bis (allyl carbonate), (CR-39) monomer. Of course, it is contemplated that the polymerizable prepolymer will be a composition which may comprise other components as is conventional in the art. For example, a suitable composition my include a polymerization initiator, a cross-linking agent, a uv absorber, or other additives conventionally used in the manufacture of lenses. Suitable prepolymers, initiators, cross-linking agents, additives and other lens materials for use in the present invention are disclosed in U.S. Pat. No. 5,882,556, Mar. 16, 1999 to Perrott et al. which is specifically incorporated by reference herein.

Suitable dyes for use herein are any of the dyes well known for use in tinting lenses. Suitable photochromic molecules for use herein are well-known in the art and include those selected from the group consisting of anthraquinones, naphtopyrans, phhalocyanines, spiro-oxazines, chromenes, pyrans including spiro-pyrans and fulgides. Suitable photochromic molecules include but are not limited to those disclosed in U.S. Pat. No. 5,882,556 Mar. 16, 1999 to Perrott et al. which is specifically incorporated by reference herein. In addition to photochromic molecules, the photochromic composition may include Uv stabilizers, antioxidants and other useful materials which may be added to enhance the life of the lens or otherwise provide benefit to the composition.

One embodiment of the method of the present invention is a method for making a gradient photochromic substrate. In accordance with this method, a mold is prepared by filling it with prepolymer liquid composition. Curing of the prepolymer is begun by heating or otherwise initiating curing as is conventional in the art and disclosed, for example, in the aforementioned U.S. Pat. No. 5,882,556. When the prepolymer composition has cured to at least its point of gelation, i.e. to a substrate having a gelatinous state, but before the polymer is completely cured, the surface layer of the substrate is contacted with an inhibiting or impairing agent to stop further crosslinking of the polymer in the surface layer. Where the reaction is a free-radical reaction, inhibition can be accomplished by contacting the surface of the substrate with air, diphenylamine (DPA), tert-butyl catechol (TBC), copper chloride, parabenzoquinone, butylated hydroxy toluene (BTH) or any other agent that will inhibit or block the free radical reaction. One alternative way of inhibiting cross-linking in the surface layer is to coat a surface of a lens mold with a free radical inhibitor in powder form before filling the mold with the prepolymer composition. Yet another way of inhibiting cross-linking is to mix an inhibitor with a carrier such as a mold release agent which is coated on the surface of the lens mold.

Preferably, the polymer in the remainder of the substrate is then cured substantially to completion by further heating or radiation or combination of and then photochromic molecules are infused or permeated into the surface layer by contacting the layer with a solution of photochromic molecules in a maimer to provide the desired gradient concentration. Alternatively, the surface layer is infused or permeated with photochromic molecules by contacting the surface with a solution of photochromic molecules in a manner to provide a gradient concentration and then the polymer in the remainder is cured substantially to completion. In either case, the photochromic molecules are infused into the layer in a gradient manner in order to obtain the desired gradient effect of the present invention.

The gradient infusion my be accomplished by bringing the photochromic moiety into contact with the surface layer of the substrate to accomplish its permeation therein by various methods including, but not limited to, gradient coating a solution containing the photochromic moiety onto the surface of the substrate, applying a gradient layer of polymeric film having the photochromic moiety dissolved or suspended therein to the surface of the substrate and then heating the film near to but below the melting point of the photochromic moiety for a time sufficient to incorporate the photochromic moiety into the surface layer, or any of the methods for incorporating photochromic compounds into a surface of a host material disclosed in U.S. Pat. No. 5,066,818 Nov. 19, 1991 to Gemert et al. for “Photochromic Naphtopyran Compounds” which patent is specifically incorporated by reference herein, so long as a gradient of photochromic molecules is infused into the surface.

However, in accordance with the present invention, particularly effective methods for applying a gradient of photochromic molecules to the surface layer have been discovered. Preferred methods include:

(1) With a laser source, treating the surface of a lens so that it is textured in a design that goes from many surface holes or locations to fewer as the lens is traversed. Then contacting the lens surface with a photochromic moeity and coating to seal in the moeity and to cover any surface imperfections.

(2) With a corona treatment device, treating the surface of a lens so that it is textured in a design that goes from many surface holes or locations to fewer as the lens is traversed. Then contacting the lens with a photochromic moeity and coating to seal in the moeity and to cover any surface imperfections.

(3) Using a thermal or uv cure coating containing photochromic molecules, repeatedly dip the substrate surface (or slowly retract the surface from) into the coating with many cycles with each cycle dipping the lens less far into the coating and then coat the surface with a scratch resistant layer to preserve the photochromic moiety. This can be accomplished by repeatedly dipping a lens attached to an Arm on a Cam that shortens it stroke each successive dip into the photochromic dye bath.

(4) Slowly withdrawing a lens that is partially submerged in a photochromic bath that is agitated to make wave on the surface of the bath while the lens is slowly withdrawn at about 2.5 mm to about 0.25 mm per minute.

(5) Slowly withdrawing a Photochromic tinted lens that is partially submerged in a heated neutralizer bath of Propylene glycol or the like, that is agitated to make waves on the surface of the bath while the lens is slowly withdrawn at about 2.5 mm to 0.25 mm per minute.

(6) Repeatedly dipping a Photochromic lens attached to an Arm on a Cam that shortens its stroke each successive dip into a hot neutralizing bath.

(7) Repeatedly dipping a Photochromic lens attached to an Ann on a Cam that shortens its stroke each successive dip into a solution of an oxidizer or any other chemical that destroys the photochromic molecules

(8) Using a High intensity UV light source that is projected onto a Photochromic lens such that the intensity of the light contacts the surface of the lenses in a gradient of intensity, thereby destroying the photochromic molecules in a proportioned manner leaving the lens with a gradient photochromic effect.

(9) Applying heat to a Photochromic tinted lens such that the heat is applied in a thermal gradient in a high enough temperature for a long enough time so as to destroy the photochromic effect in a gradient pattern.

(10) Applying a free radical inhibitor onto at least one surface of a lens mold in a gradient matter such that the resultant partial cured or fully cured lens has more porosity or cross-linked impaired areas in a gradient manner.

(11) Applying a free radical inhibitor to a partially cured lens by repeatedly dipping to a lesser extent or slowing withdrawing the lens from the inhibiting solution such that a gradient cross-linking impaired surface is created, post curing the lens and then totally immersing the lens into, or gradient dipping the lens into, or slowly withdrawing the lens from, a photochromic tint bath to achieve a gradient Photochromic lens.

(12) Using a photochromic charged carrier film which carries the photochromic moiety in a gradient by applying it to an optical lens that is partially cured or fully cured, using a heat source to transfer the photochromic molecules by imibition or sublimation into the lens to provide a lens having a gradient photochromic effect.

(13) Silkscreening in a gradient pattern a Photochromic dye in an ink form onto the surface of a lens then, heating the lens and dyes so as to melt the dye onto the surface of the lens and optionally then coating the lens to make it scratch resistant.

(14) Electrostatically coating a lens with a photochromic dye in a manner that causes the electrostatic deposition to be in a gradient across the lens. Then heating the lens to the melting point of the dye and optionally then coating the lens to make it scratch resistant.

(15) Selectively mask coating a photochromic tinted lens with a coating using any method such as silk screening, electrostatic mask coating, spin mask coating, or tape that is perforated in a gradient pattern; such that the mask coat will allow exposure of the lens in a gradient manner so that unmasked areas when immersed in a UV inhibitor will allow the inhibitor to deactivate the dye by absorbing the UV light before it activates the Photochromic dye. The mask coating is then removed.

(16) Selectively mask coating a photochromic tinted lens with a coating using any method such as silkscreening, electrostatic mask coating, spin coating, or tape that is perforated in a gradient pattern; such that the mask coat will allow exposure of the lens in a gradient manner so that unmasked areas when immersed in an agent such as an oxidizer will allow the agent to destroy the Photochromic dye. The mask coating is then removed.

(17) Selectively mask coating a cross-linked impaired or a normally cured lens with a mask coating using any method such as silkscreening, electrostatic mask coating, spin coating, tape that is perforated in a gradient pattern; such that the mast coat allow expose of the lenses in areas that are gradient to the extent that the unmasked area when contacted with a Photochromic dye becomes a gradient Photochromic lens. The mask is then removed

(18) Coating as least one optical surface of a lens mold with an inert powder in a gradient pattern. Mold and cure the lens as a normal lens. Leach out the inert material. Imbibe the lens with a photochromic material. The resultant lens will be gradient photochromic.

(19) Short curing a lens, remove it from the mold, and imbibe it with a solution of inert material by dipping or by slow withdrawal method such that the inert material is absorbed by the lenses in a gradient manner. Post Curing the lens and then leaching the inert material out of the lens. The lens is then imbibed with a Photochromic dye by immersion or the like. The resultant lens will be gradient photochromic.

Further understanding of the present invention will be had from the following examples.

### EXAMPLE 1

Diethylene glycol bis(allyl carbonate) (CR39) monomer from PPG is mixed with an aliphatic peroxy initiator diisoproypyl peroxydicarbonate and injected into a glass mold to produce a 70 mm round by 2 mm thick plano lens blank. The mold is then placed in a curing oven that is cycled to reach a maximum temperature 0f 78° C. within 16 hours. During this time the monomer polymerizes to a gelled state. The mold is removed from the curing oven, quenched in ice water and the gelled lenses are removed from the molds and immediately contacted with the atmosphere which acts as a free radical inhibitor.

The lens has a porous surface layer with a less cross-linked structure. The porous surface has many ideal interstitial spaces in the surface layer for photochromic molecules to reside.

The lens is placed back into the curing oven for post curing in the presence of air, which at elevated temperatures is a good inhibitor, for 4 hours to complete the curing of the lens.

The surface of the lens is then contacted with a photochromic solution in a gradient manner by repeatedly dipping the lens into a bath of the photochromic solution for many cycles with each cycle dipping the lens less deeply into the bath, which imbibes, absorbs or infuses photochromic moieties into the porous surface layer in a gradient manner. The photochromic solution is Reversacal Corn yellow from Keystone Aniline Corporation. The resultant lens exhibits superior Photochromic qualitites. It is then treated with UV inhibitors and scratch resistant coated to enhance the life of the Photochromic effect and the scratch resistance of the treated lens.

### EXAMPLE 2

The procedure of Example 1 is followed except that the lens is contacted with a solution of 5% DHP in toluene while still in the mold instead of the atmosphere, then the lens is removed from the mold and the procedures of Example 1 are followed. The photochromic solution is Reversacal Berry Red from Keystone Aniline Corporation.

### EXAMPLE 3

The procedure of Example 2 is followed except that after contacting with 5% BHT solution, the lens is cleaned and post cured for 4 hours at 80 C. and then tinted with photochromic material. The photochromic material is Reversacal Plum Red from Keystone Aniline Corporation.

### EXAMPLE 4

The procedure of Example 1 is followed except that the lens is contacted with 3% solution of BHT in toluene, cleaned and post cured for 4 hours at 80 C. The lens is then tinted with photochromic material in a gradient manner as in Example 1. The photochromic material is Reversacal Midnight Gray from Keystone Aniline Corporation.

### EXAMPLE 5

The lens of Example 1 is taken and then repeatedly dipped in a bath of a solution of propylene glycol, DE and silicone oil. Some of the photochromic material was removed from the lens by the solution providing a gradient effect. The removed photochromic material was then recycled to the tinting solution.

### EXAMPLE 6

The method of Example 1 is followed except that after the lens is removed from the mold and the surface layer is inhibited, the surface layer is imbibed with an inert substance, an azo compound. Then after the lens is post cured, the azo compound is leached from the lens in a gradient manner using a hot solution of propylene glycol. Then the lens is contacted with a photochromic material which is imbibed into the surface layer of the lens.

What is claimed is;

1. A substrate having an organic polymeric matrix layer containing a tinting material selected from the group consisting of a dyes and photochromic moieties, said tinting material being present in said layer in a gradient concentration.

2. A substrate as in claim 1 wherein said layer comprises a homogeneous polymeric matrix.

3. A substrate as in claim 1 wherein said substrate is an optical lens.

4. A substrate as in claim 3 wherein said tinting material is a photochromic moiety.

5. A substrate as in claim 4 wherein said polymer is a multifunctional polycarbonate polymer.

6. A substrate as in claim 4 wherein said polymer is an acrylic polymer.

7. A substrate as in claim 4 wherein said tinting material is a dye.

8. A substrate as in claim 1 wherein a portion of said layer comprises an amount of photochromic moiety sufficient to be opaque when activated.

9. A substrate as in claim 1 wherein said substrate has at least one additional layer, said additional layer having a different chemical constitution than said layer.

10. A substrate as in claim 1 wherein said substrate is a layer in a laminated article.

11. A substrate as in claim 1 wherein said substrate is in operative association with an automotive vehicle.

12. A substrate as in claim 1 wherein said substrate is associated with an architectural structure.

13. A transparent optical lens having a first homogeneous layer of a substantially cured organic polymer and a second homogeneous layer of a partially cured organic polymer, said second layer comprising an effective amount of a photochromic moiety in a gradient concentration.

14. A lens as in claim 13 wherein said first layer and said second layer are formed from an identical prepolymer.

15. An lens as in claim 13 wherein said organic polymer is a multifunctional polycarbonate polymer.

16. A method of making an article containing a tinting material present in a layer of said article in a gradient concentration, said method comprising the steps of:
polymerizing a crosslink able prepolymer to form a partially cured substrate, said substrate having a surface and an associated surface layer;
inhibiting further polymerization of said prepolymer in said surface layer of said substrate, thereby providing an inhibited surface layer and an uninhibited partially cured substrate portion; and
Contacting said surface layer of inhibited partially cured substrate with an effective amount of a photochromic moiety in a manner to infuse said moiety in said substrate in a gradient concentration.
